(19) United States
(12) Patent Application Publication
(10) Pub. No.: US 2011/0231229 A1
(43) Pub. Date: Sep. 22, 2011

(54) Hybrid Software Component and Service Catalog

(75) Inventor: Ethan Hadar, Nesher, IL (US)

(73) Assignee: Computer Associates Think, Inc., Islandia, NY (US)

(21) Appl. No.: 12/728,616

(22) Filed: Mar. 22, 2010

(51) Int. Cl. G06Q 10/00

(52) U.S. Cl. 705/7.38

(57) ABSTRACT

A hybrid software component and service catalog is disclosed. A method according to embodiments of the present disclosure includes identifying a plurality of existing information technology services in an enterprise, wherein each of the plurality of existing information technology services includes a plurality of attributes. The method also includes assigning a quality metric associated with one or more attributes of each of the respective identified existing information technology services. The method also includes identifying a plurality of potential information technology services, wherein each of the plurality of potential information technology services includes a plurality of attributes. Additionally, the method includes receiving a quality metric associated with one or more attributes of each of the respective identified potential information technology services from a source external to the enterprise. The method further includes determining a threshold associated with a selected one of the existing information technology services and comparing the quality metric associated with the selected one of the existing information technology services to the quality metric associated with a selected one of the potential information technology services. The method also includes based at least in part on the comparison and the determined threshold, displaying the potential information technology resource to a user.

### TECHNICAL FIELD OF THE INVENTION

The invention relates generally to information technology management, and more particularly to a hybrid software component and service catalog.

### BACKGROUND OF THE INVENTION

Information technology departments have as a goal the maximization of existing information technology investments, and to further that goal, they may select the best future investments according to efficiency or return on investment metric. To that end, information technology departments are constantly optimizing their technology infrastructure and deployments for maximal return.

Selecting a solution, or software components and services, starts with the ability to reuse or reactivate existing and past information technology investments, with minimal new adjustments. Accordingly, information technology managers may insert new ones based on needs and proactive forecasting of changes. The optimization can be done by replacing service agreements, tuning according to actual consumption of services, and adjusting service levels.

Whether it is a fully installed software component with known interfaces, or an information technology services that is consumed using a Software as a Service model, there are several alternatives of presumably identical functional and business value, but with different non-functional (such as, for example, cost, performance, scalability, availability, etc) properties that may differentiate between them.

### SUMMARY OF THE INVENTION

In accordance with the present disclosure, the disadvantages and problems associated with information technology catalog systems have been substantially reduced or eliminated.

In accordance with one embodiment of the present disclosure, a method includes identifying a plurality of existing information technology services in an enterprise, wherein each of the plurality of existing information technology services includes a plurality of attributes. The method also includes assigning a quality metric associated with one or more attributes of each of the respective identified existing information technology services. The method also includes identifying a plurality of potential information technology services, wherein each of the plurality of potential information technology services includes a plurality of attributes. Additionally, the method includes receiving a quality metric associated with one or more attributes of each of the respective identified potential information technology services from a source external to the enterprise. The method further includes determining a threshold associated with a selected one of the existing information technology services and comparing the quality metric associated with the selected one of the existing information technology services to the quality metric associated with a selected one of the potential information technology services. The method also includes based at least in part on the comparison and the determined threshold, displaying the potential information technology resource to a user.

In accordance with another embodiment of the present disclosure, a system includes an enterprise catalog operable to identify a plurality of existing information technology services in an enterprise, wherein each of the plurality of existing information technology services includes a plurality of attributes and assign a quality metric associated with one or more attributes of each of the respective identified existing information technology services. The system also includes a potential catalog operable to identify a plurality of potential information technology services, wherein each of the plurality of potential information technology services includes a plurality of attributes and receive a quality metric associated with one or more attributes of each of the respective identified potential information technology services from a source external to the enterprise. The system also includes an optimizing server operable to determine a threshold associated with a selected one of the existing information technology services and compare the quality metric associated with the selected one of the existing information technology services to the quality metric associated with a selected one of the potential information technology services. The optimizing server is also operable to, based at least in part on the comparison and the determined threshold, display the potential information technology resource to a user.

In accordance with yet another embodiment of the present disclosure, a computer readable non-transitory medium is encoded with logic, and the logic is operable, when executed on a processor to identify a plurality of existing information technology services in an enterprise, wherein each of the plurality of existing information technology services includes a plurality of attributes and assign a quality metric associated with one or more attributes of each of the respective identified existing information technology services. The logic is also operable to identify a plurality of potential information technology services, wherein each of the plurality of potential information technology services includes a plurality of attributes. Additionally, the logic is operable to receive a quality metric associated with one or more attributes of each of the respective identified potential information technology services from a source external to the enterprise. The logic is further operable to determine a threshold associated with a selected one of the existing information technology services and compare the quality metric associated with the selected one of the existing information technology services to the quality metric associated with a selected one of the potential information technology services. The logic is also operable to, based at least in part on the comparison and the determined threshold, display the potential information technology resource to a user.

Technical advantages of particular embodiments of the present disclosure include providing IT managers with visibility into their overall extended inventory, not only the ones that are in production, and seamlessly adding potential extensions of “pay-per-use” services that can become part of the portfolio of offerings. Moreover, particular embodiments maintain non-functional values of IT services and provide automatic discovery tools that can measure the utilization (licensing trends), service level issues (by examining service desk tickets and other quality measuring services), cost of investments, or explore its importance. Particular embodiments, configured with business rules by tool users, provide a constant dashboard to IT managers for triggering change management, or proactive sensing of business opportunities. Thus, users will have “hands-on” watchdogs over changes in offerings, and align them to their specific business needs. Additionally, the system may function as an IT services crawler that highlights opportunities. The system can be used for documenting and capturing components currently in research and development, not necessarily in a production environment, since it has the basic element of a warehouse that holds “non-deployed” components. In such a case, enterprise architects as well as research and development architects, can search for compatible services and possible candidate components to develop new applications. The active components and services that are captured in the system are providing more than regular interfaces exposure, and are providing visibility into the different values of the existing components, thus selecting the best service or component. When populated with components and services, some of the components expose interfaces that participate in existing out-of-the-box integration, using a Unified Service Model. Since the catalogs can maintain many attributes, including requestors, it is possible to construct the overall enterprise usage architecture reference blueprint, and define changes, as well as architecture evolution needs.

Other technical advantages of the present disclosure will be readily apparent to one skilled in the art from the following figures, description, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description taken in conjunction with the accompanying drawings, in which:

FIG. 1 illustrates a system in accordance with particular embodiments of the present disclosure, including an enterprise catalog, a potential catalog, an optimizing server, and a network;

FIG. 2 illustrates the optimizing server illustrated in FIG. 1 in more detail, including aspects of the present disclosure; and

FIG. 3 is a flow chart illustrating a particular operation of the system of FIG. 1 in accordance with particular embodiments of the present disclosure.

### DETAILED DESCRIPTION OF THE INVENTION

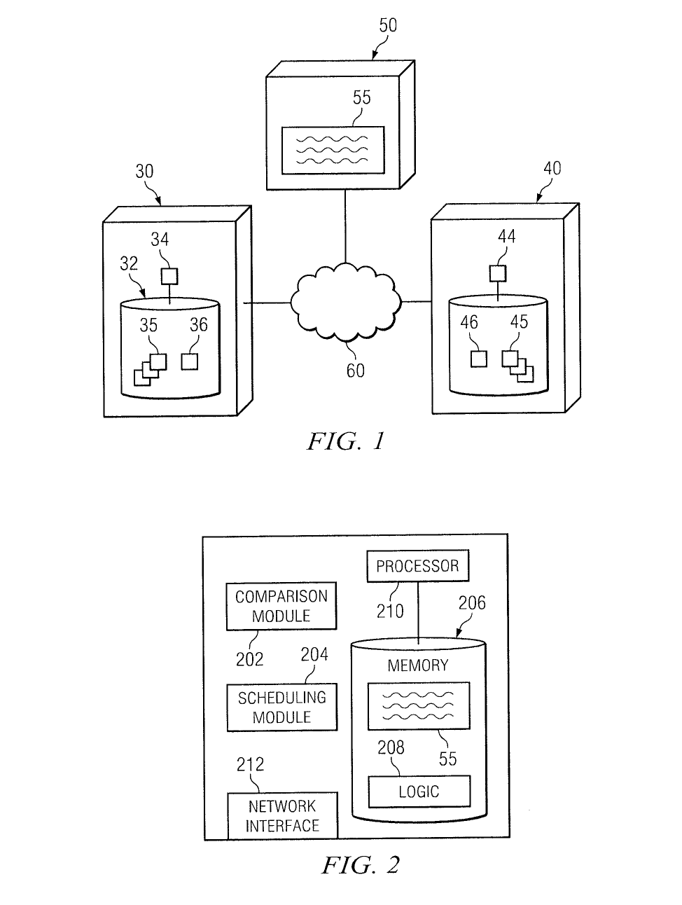

FIG. 1 illustrates a information technology catalog system 10 in accordance with certain embodiments. System 10 includes enterprise catalog 30, potential catalog 40, optimizing server 50, optimizing catalog 55, and network 60. System 10 is generally operable to evaluate, monitor and recommend enhancements, improvements and/or changes to an enterprise's information technology infrastructure. Enterprise catalog 30 stores service information 35. Service information 35 is associated with internal IT services. Potential catalog 40 stores service information 45. Service information 45 is associated with potential IT services. Optimizing server 50 monitors enterprise catalog 40 and potential catalog 40, comparing service information 35 with service information 45. If the difference between service information 45 and service information 35 is greater than a predetermined threshold, optimizing server 50 may recommend replacing, enhancing, supplementing, and/or changing an IT service associated with service information 35 with an IT service associated with service information 45.

For purposes of this description, an IT service may represent any service, hardware, software, process, and/or device associated with processing power, storage, software applications, software and/or hardware licenses or any other computing resource. An existing IT service represents an IT service currently deployed in an enterprise. An existing IT service may represent an active or inactive IT service. An IT service designated as active indicates that the IT service is in use within the enterprise, or in development or production stages. An IT service designated as inactive indicates that it the IT service is purchased and/or developed, but not currently in use. In particular embodiments, an IT service may represent a service providing for storage of electronic or computer data. As another example, an IT service may represent an employee's desktop computer. As another example, an IT service may represent an datacenter server. As another example, an IT service may represent a license for a software application. As another example, an IT service may represent a software application. As another example, an IT service represents a service allowing for access to processing power over a computer network. As another example, an IT service may represent Software as a Service, hosted on a server and/or cloud external to the enterprise.

Optimizing server 50 monitors service information 35 in enterprise catalog 30 and/or service information 45 in potential catalog 40 for potential enhancements to the IT infrastructure deployed within enterprise. In some embodiments, enterprise catalog 30 receives quality metrics associated with an IT service deployed within an enterprise. Enterprise catalog 30 may assign quality metrics and/or other information associated with an existing IT service to an existing IT service, and store the quality metrics in service information 35. Potential catalog 45 receives quality metrics and/or other information associated with a potential IT service. Potential catalog 40 stores the quality information and/or other information associated with the IT service as service information 45.

In some embodiments, a user may establish a threshold for enhancing and/or changing IT services within the enterprise. The particular type of threshold established may be dependent on the associated type of IT service. For example, an existing IT service may represent data storage on a public cloud costing $1 per gigabyte per month. A user may establish a threshold of $0.10. In this case, if optimizing server 50 discovers in potential catalog 30 an IT service that meets or exceeds this threshold (i.e., costs $0.90 per gigabyte per month or less), then system 10 may recommend replacing the existing IT service with the potential IT service. As another example, an enterprise has a software application installed throughout its user base. Based on user feedback, enterprise catalog 30 assigns a quality metric of 5 (where 1 is poor, and 10 is excellent) to the software application. A user may establish a threshold of 2. If optimizing server 50 discovers in potential catalog 30 a functionally similar software application with a quality metric that meets or exceeds this threshold (i.e., has a quality metric of 7 or greater), then optimizing server 50 may recommend replacing the existing software application with the software application discovered in potential catalog 40.

In some embodiments, optimizing server 50 may periodically monitor enterprise catalog 30 and potential catalog 40 to determine whether existing IT services should be enhanced and/or replaced. Optimizing catalog 55 may store which particular IT services optimizing server 50 will periodically monitor. Optimizing server 50 may store a comparison schedule associated with service information 35 and/or existing IT service in optimizing catalog 55. A comparison schedule may indicate specific times and/or rules that determine when optimizing server 50 will compare an existing IT service to a potential IT service. In particular embodiments, a comparison schedule may be associated with service information 35. In some embodiments, optimizing catalog 55 store monitoring rules that define which IT services to monitor. For example, a monitoring rule may specify that optimizing server 50 will monitor all IT services that cost more than $20 per day. Using service information 35, which includes cost information, optimizing server 50 monitors IT service that match the criteria. In some embodiments, a user may specify one or more IT services to monitor. For example, a user may specify that all software licenses associated with will be monitored.

Enterprise catalog 30 receives and stores information associated with existing IT services in an enterprise. Existing IT services may be provided by the enterprise and/or a third party external to the enterprise. For example, an existing IT service may be provided by the enterprise by being purchased and/or acquired and deployed, installed, and/or otherwise put into use within the enterprise. As a result, an existing IT service may be managed, operated, and/or controlled by the enterprise. An existing IT service may be provided by an external third party source by being purchased as a service. For example, an enterprise may purchase access to an IT service that is available to the enterprise via a third party application provider, service provider, data storage provider and/or other software as a service provider. Once subscribed to, in use, and/or installed in the enterprise, the IT service provided by an external third party may be an existing IT service. In particular embodiments, enterprise catalog 30 stores a particular service information 35 for each existing IT service in an enterprise. Thus, each particular service information 35 stored in enterprise 30 is associated with a particular existing IT service. Enterprise catalog 30 may assign one or more quality metrics to an existing IT service based on the received information. Enterprise catalog 30 may store one or more quality metrics in service information 35. In particular embodiments quality metrics store in service information 35 include, but are not limited to, the cost of an IT service, the number of instances of the IT service deployed in the enterprise, performance metrics, user ratings, expert ratings, consumption profiles (i.e., who and when is using the IT service), and usability issues. In particular embodiments, a quality metric stored in service information 35 may indicate an overall quality rating on a fixed or relative scale. Enterprise catalog 30 transmits service information 35 to optimizing server 50 in response to a request from optimizing server 50 and/or in response to updated service information 35.

Enterprise catalog 30 comprises memory 32 and processor 34. Memory 32 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 32 as internal to enterprise catalog 30, it should be understood that memory 32 may be internal or external to enterprise catalog 30, depending on particular implementations. Memory 32 may be separate from or integral to other memory devices to achieve any suitable arrangement of memory devices for use in system 10.

Memory 32 stores service information 35 and/or any other information associated with existing IT services in an enterprise. Memory 32 also stores logic 36. Logic 36 generally comprises rules, algorithms, code, tables, and/or other suitable instructions for offering and/or providing information technology services.

Memory 32 is communicatively coupled to processor 34. Processor 34 is generally operable to execute logic 36 to perform the functionality provided by enterprise catalog 30. Processor 34 comprises any suitable combination of hardware and software implemented in one or more modules to provide the described function or operation.

Potential catalog 40 receives and stores information associated with potential IT services available for deployment within an enterprise. Potential IT services may be provided by the enterprise and/or a third party external to the enterprise. For example, an IT service may be provided by the enterprise by being purchased and/or otherwise acquired, but not yet deployed or installed in the enterprise. An IT service may be provided by a third party external to the enterprise by being available for purchase and/or acquisition and to be installed in the enterprise. Once installed, deployed and/or otherwise in use within the enterprise, a potential IT service may be an existing IT service. In some embodiments, potential catalog 40 receives information associated with potential IT services from a third-party information source. Potential catalog 40 may be maintained, managed, operated and/or controlled by a third-party and provided to an enterprise as a service. In some embodiments, potential catalog 40 may be maintained, managed, operated, and/or controlled by an enterprise, and receive updates from a third party source. In some embodiments, potential catalog stores a particular service information 45 for each potential IT service. Potential catalog 40 receives one or more quality metrics associated with a potential IT service and may store the quality metrics in service information 45. In general service information 45 indicates any information associated with the relevant potential IT service. In particular embodiments, service information 45 includes, but is not limited to, the type of IT service, the cost of an IT service, performance metrics, user ratings, expert ratings, and usability issues. In particular embodiments, service information 45 may indicate an overall quality metric on a fixed or relative scale. Potential catalog 30 transmits service information 45 to optimizing server 50 in response to a request from optimizing server 50 and/or in response to updated service information 45.

Potential catalog 40 comprises memory 42 and processor 44. Memory 42 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 42 as internal to potential catalog 40, it should be understood that memory 42 may be internal or external to enterprise catalog 40, depending on particular implementations. Memory 42 may be separate from or integral to other memory devices to achieve any suitable arrangement of memory devices for use in system 10.

Memory 42 stores service information 45, and/or any other information associated with potential IT services available for deployment within an enterprise. Memory 42 also stores logic 46. Logic 46 generally comprises rules, algorithms, code, tables, and/or other suitable instructions for offering and/or providing information technology services.

Memory 42 is communicatively coupled to processor 44. Processor 44 is generally operable to execute logic 46 to perform the functionality provided by potential catalog 40. Processor 44 comprises any suitable combination of hardware and software implemented in one or more modules to provide the described function or operation.

Optimizing server 50 monitors existing catalog 30 and potential catalog 40, compares service information 35 and service information 45, and, based on the comparison, offers to enhance or change existing IT services. In particular embodiments, optimizing server 50 identifies existing and potential IT services by scanning and/or querying enterprise catalog 30 and/or potential catalog 40. In some embodiments, optimizing server 50 stores information associated with existing and potential IT services in optimizing catalog 55. Optimizing catalog 55 may information associated with particular IT services that optimizing server 50 will periodically monitor. In some embodiments, optimizing catalog 55 stores service information 35 and/or service information 45. In some embodiments, optimizing server 50 uses monitoring rules stored in optimizing catalog 55 that define which IT services to monitor. For example, a monitoring rule may specify that optimizing server 50 will monitor all IT service that cost more than $20 per day. Using service information 35, which includes cost information, optimizing server 50 monitors any IT service that matches the criteria. In some embodiments, a user may specify one or more IT services to monitor. For example, a user may specify that all software licenses will be monitored. In such cases, optimizing server 50 monitors enterprise catalog 30 and potential catalog 40 for IT services that are software licenses.

Each of enterprise catalog 30, potential catalog 40, and optimizing server 50 comprises any suitable combination of hardware and/or software implemented in one or more modules to provide the described functions and operations. In some embodiments, enterprise catalog 30, potential catalog 40, and optimizing server 50 may comprise a general-purpose personal computer (PC), a Macintosh, a workstation, a Unix-based computer, a server computer, or any suitable processing device. In some embodiments, the functions and operations described above may be performed by a pool of multiple enterprise catalog 30, potential catalog 40, and optimizing server 50. In some embodiments, enterprise catalog 30, potential catalog 40 and optimizing catalog 55 represent relational database applications executing on any suitable processing device.

Enterprise catalog 30, potential catalog 40, and optimizing server 50 are communicatively coupled via one or more networks 60. Network 60 may represent any number and combination of wireline and/or wireless networks suitable for data transmission. Network 60 may, for example, communicate internet protocol packets, frame relay frames, asynchronous transfer mode cells, and/or other suitable information between network addresses. Network 60 may include one or more intranets, local area networks, metropolitan area networks, wide area networks, cellular networks, all or a portion of the Internet, and/or any other communication system or systems at one or more locations.

In operation, optimizing server 50 periodically compares service information 35 stored in enterprise catalog 30 to service information 45 stored in potential catalog 40 to determine whether an existing IT service in an enterprise should be enhanced and/or changed. At appropriate points during operation, enterprise catalog 30 receives and stores information associated with existing IT services within an enterprise. Enterprise catalog 30 may receive information associated with existing IT services from another database within an enterprise, such as, for example, a help desk database that monitors problems associated with an IT service and/or tracks user reviews of an IT service. Enterprise catalog 30 may also receive information associated with existing IT services from users entering information into an interface of enterprise catalog 30. Enterprise catalog 30 stores information associated with existing IT service in service information 35. In particular embodiments, enterprise catalog 30 stores a particular service information 35 for each IT service in an enterprise. Thus, each particular service information 35 stored in enterprise 30 is associated with a particular existing IT service. Enterprise catalog 30 assigns one or more quality metrics to a particular IT service in service information 35. A quality metric may indicate a level of quality associated with one or more attributes of a relevant IT service, such as, for example, reliability, cost, performance, stability, usability, user ratings, and/or expert ratings. In particular embodiments, service information 35 may include an overall quality metric on a fixed or relative scale. Enterprise catalog 30 transmits service information 35 to optimizing server 50 in response to a request from optimizing server 50 and/or in response to updated service information 35.

At appropriate points during operation, potential catalog 40 receives and stores information associated with potential IT services available for deployment within an enterprise. In some embodiments, potential catalog 40 receives information associated with potential IT services from a third-party information source. For example, an enterprise may subscribe to a catalog service that maintains and updates information on available IT services. Users may be able to select which types of IT services potential catalog 40 stores information about. In some embodiments, potential catalog 40 stores information associated with a potential IT service in service information 45. Potential catalog 40 may store a particular service information 45 for each potential IT service. Service information 45 may include information associated with attributes of a particular IT service. Service information 45 may include any information relevant to an evaluation of potential IT service. Potential catalog 40 indicates one or more quality metrics associated with a particular potential IT service in service information 45. A quality metric may indicate a level of quality associated with one or more attributes of a relevant IT service, such as, for example, reliability, cost, performance, stability, usability, user ratings, and/or expert ratings. In particular embodiments, service information 45 may include an overall quality rating on a fixed or relative scale. Potential catalog 40 transmits service information 45 to optimizing server 50 in response to a request from optimizing server 50 and/or in response to updated service information 45.

Once enterprise catalog 30 and potential catalog 40 have stored service information 35 and service information 45, respectively, optimizing server 50 identifies an IT service in enterprise catalog 30 and an IT service in potential catalog 40. Optimizing server 50 may identify an IT service by retrieving information associated with one or more IT services from optimizing catalog 55. As discussed above, optimizing catalog 55 stores service information 35 and/or service information 45, and/or monitoring rules that identify IT services to monitor that meet predefined criteria.

Optimizing server 50 determines a threshold associated with the identified IT service. In particular embodiments, a threshold associated with each IT service in an enterprise may be stored in service information 35. In particular embodiments, a user may input into an interface of optimizing server 50 a threshold for each IT service, which optimizing server 50 stores in an associated service information 35 in enterprise catalog 30 and/or optimizing catalog 55. Optimizing server may determine a threshold associated with the identified IT service by retrieving the stored threshold from enterprise catalog 30 and/or optimizing catalog 50. Optimizing server 50 compares one or more quality metrics in service information 35 to one or more quality metrics in service information 45, and, based on the comparison and the threshold associated with the relevant IT service, optimizing server 50 may offer to enhance and/or replace the existing IT service associated with service information 45 with the potential IT service associated with service information 35. For example, an existing IT service represents data storage in a datacenter of an enterprise. Based on usability, performance, stability, cost, and/or other relevant metrics, enterprise catalog 30 assigns an overall quality metric to the data storage of 78 on a scale of 1 to 100. Potential catalog 40 includes service information 45 that identifies a potential data storage provided by a third party. The potential data storage may be offered as a Software as a Service application. Additionally, service information 45 indicates that the potential data storage provided by a third party has an overall quality metric of 85 on a scale of 1 to 100. Service information 35 indicates that the existing IT service has a threshold of 10. That is, if a similar potential IT service has a quality metric greater than 10, then optimizing server will offer to enhance and/or change the existing IT service. In this example, optimizing server will compare service information 35 (having quality metric 78) to service information 45 (having quality metric 85) and the associated threshold of 10. In this example, optimizing server 50 performs no further actions, because the difference in quality metrics is not greater than the threshold. If the potential IT service had a quality metric of 95, optimizing server 50 offers to change and/or enhance the existing IT service. Optimizing server 50 may offer to change and/or enhance the existing IT service by displaying a notification and identifying the potential IT service on a display associated with optimizing server 50. In general however, optimizing server 50 may offer to change and/or enhance the existing IT service in any suitable manner to inform a user of system of the potential IT service.

Optimizing server 50 compares an existing IT service in an enterprise to potential IT services available for deployment in an enterprise and a threshold associated with the existing IT service. Based on the comparison, optimizing server 50 offers to enhance and/or change an existing IT service. As a result, optimizing server 50 provides numerous operational benefits. For example, using the provided enterprise catalog 30, potential catalog 40, and/or optimizing catalog 50, IT managers have visibility into their overall extended inventory, not only the ones that are in production, seamlessly adding potential extension of “pay-per-use” services that can become part of the portfolio of offerings. Moreover, the system 10 maintains non-functional values of IT services. Particular embodiments of system 10 provide automatic discovery tools that can measure the utilization (licensing trends), service level issues (by examining service desk tickets and other quality measuring services), cost of investments, or explore its importance. Optimizing server 50, configured with business rules by the tool users, provides a constant dashboard to IT managers for triggering change management, or proactive sensing of business opportunities. Thus, users will have “hands-on” watchdogs over changes in offerings, and align them to their specific business needs. In particular embodiments, system 10 may function as an IT services crawler that highlights opportunities. System 10 can be used for documenting and capturing research and development components, not necessarily in a production environment, since it has the basic element of a warehouse that holds “non-deployed” components. In such a case, enterprise architects as well as research and development architects, can search for compatible services and possible candidate components to develop new applications. The active components and services that are captured in the system are providing more than regular interfaces exposure, and are providing visibility into the different values of the existing components, thus selecting the best service or component. When populated with components and services, some of the components expose interfaces that participate in existing out-of-the-box integration, using Unified Service Model fashion. Since enterprise catalog 30 and potential catalog 40 and can maintain many attributes, including requestors, it is possible to construct the overall enterprise usage architecture reference blueprint, and define changes, as well as architecture evolution needs.

As a result, system 10 may provide numerous operational benefits. Nonetheless, particular embodiments may provide some, none, or all of these operational benefits, and may provide additional operational benefits.

Modifications, additions, or omissions may be made to system 10 without departing from the scope of the invention. For example, in the illustrated embodiment, enterprise catalog 30, potential catalog 40, and optimizing server 50 are represented as different components of system 10. However, the functions of enterprise catalog 30, potential catalog 40, and optimizing server 50 may be performed by any suitable combination of one or more servers or other components at one or more locations. In the embodiment where the various components are servers, the servers may be public or private servers, and each server may be a virtual or physical server. The server may include one or more servers at the same or at remote locations. Also, enterprise catalog 30, potential catalog 40, and optimizing server 50 may include any suitable component that functions as a server. Additionally, system 10 may include any number of enterprise catalog 30, potential catalog 40, and optimizing server 50. Any suitable logic may perform the functions of system 10 and the components within system 10.

FIG. 2 is a block diagram illustrating aspects of the optimizing server 50 discussed above with respect to FIG. 1. As discussed above, optimizing server 50 periodically compares service information 35 stored in enterprise catalog 30 to service information 45 stored in potential catalog 40. Based on the comparison, optimizing server 50 may offer to enhance and/or change an existing IT service in an enterprise. Optimizing server 50 includes optimizing catalog 55, comparison module 202, scheduling module 204, memory 206, processor 208, logic 210, and network interface 212.

Optimizing catalog 55 may store information associated with existing IT services and/or potential IT service that optimizing server 50 monitors. For example, in particular embodiments, optimizing catalog 55 stores service information 35 and/or service information 45. In some embodiments, optimizing catalog 55 stores monitoring rules that define which IT services to monitor. Optimizing server 50 may monitor one or more existing IT service based on monitoring rules stored in optimizing catalog 55. Monitoring rules may be specified manually, or based on business criteria, such as expenditure and burn rate. For example, a monitoring rule may specify that optimizing server 50 will monitor all IT services that cost more than $20 per day. Using service information 35, which includes cost information, optimizing server 50 monitors any IT service that matches the criteria. In some embodiments, a user may specify one or more IT services to monitor. For example, a user may specify that all software licenses will be monitored. In such cases, optimizing server 50 monitors enterprise catalog 30 and potential catalog 40 for IT services that are software licenses.

Comparison module 202 compares service information 35 associated with an identified existing IT service to a service information 45 associated with a potential IT service. Comparison module 202 may identify an IT service to monitor based on monitoring rules established in optimizing catalog 55, an IT service identified in optimizing catalog 55, input received from scheduling module 204, or through any other appropriate method. In particular embodiments, comparison module 202 determines a threshold associated with the identified IT service. As discussed above, a threshold associated an identified IT service may be stored in service information 35. Comparison module 202 may determine a threshold associated with the identified IT service by retrieving the stored threshold from enterprise catalog 30 and/or optimizing catalog 50. Optimizing server 50 compares one or more quality metrics in service information 35 to one or more quality metrics in service information 45, and, based on the comparison and the threshold associated with the relevant IT service, comparison module 202 may offer to enhance and/or replace the existing IT service associated with service information 35 with the potential IT service associated with service information 45. In particular embodiments, enhancing an IT service may represent purchasing more of an IT service, purchasing an improved service level, spending less on an existing IT service, and/or any other appropriate functional or non-functional change to an existing IT service. Replacing an IT service may represent discontinuing the usage of an existing IT service, and deploying the identified potential IT service in its place.

Scheduling module 204 determines appropriate times for comparison module 202 to compare service information 35 associated with a particular existing IT service to service information 45 associated with a potential IT service. In particular embodiments, scheduling module 204 receives a comparison schedule associated with a particular existing IT service. In some embodiments, a comparison schedule may be associated with each existing IT service stored in enterprise catalog 30. For example, a comparison schedule may be stored in service information 35, and may identify an existing IT service and/or one or more potential IT services. A comparison schedule may identify particular times at which to compare an existing IT service to one or more potential IT services and/or rules for scheduling comparisons. For example, a comparison schedule may specify, for a particular existing IT service, that comparison module 202 compares the relevant existing IT service on the first of every month, at 12:00 A.M. As another example, a comparison schedule may specify, for a particular existing IT service, that comparison module 202 compares the relevant existing IT service whenever an overall quality metric falls below a particular metric. Comparison module 202 may then compare an existing IT service to a potential IT service whenever an overall quality metric (and/or any particular quality metric) falls below, for example, 5 on a scale of 1 to 10. A comparison schedule associated with each existing IT service may be stored in enterprise catalog 30 and/or optimizing catalog 55.

Memory 206 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 2 illustrates memory 206 as internal to optimizing server 50, it should be understood that memory 206 may be internal or external to optimizing server 50, depending on particular implementations. Memory 206 may be separate from or integral to other memory devices to achieve any suitable arrangement of memory devices for use in system 10.

Memory 206 is generally operable to store optimizing catalog 55, service information 35, service information 45, and/or any other information associated with existing and/or potential IT services. Memory 206 is further operable to store logic 208.

Processor 210 is coupled to memory 206 and is generally operable to execute logic 208 to compare existing IT services to potential IT services, and, based on the comparison and a threshold, offer to enhance and/or change the existing IT service. Processor 210 comprises any suitable combination of hardware and software implemented in one or more modules to provide the described function or operation.

Network interface 212 communicates information relevant to the comparison of existing IT service to potential IT services between enterprise catalog 30 and potential catalog 40. For example, network interface 212 receives service information 35 from enterprise catalog 30 and service information 45 from potential catalog 45 through network 60. Network interface 212 represents any port or connection, real or virtual, including any suitable hardware and/or software that allow optimizing server 50 to exchange information with network 60, enterprise catalog 30, potential catalog 40, and/or or other components of system 10.

In general, each of optimizing catalog 55, comparison module 202, scheduling module 204, memory 206, logic 208, processor 210, and network interface 212 represent any appropriate combination of hardware and/or software suitable to perform the described functions. Additionally, any two or more of service providing optimizing catalog 55, comparison module 202, scheduling module 204 may include common elements.

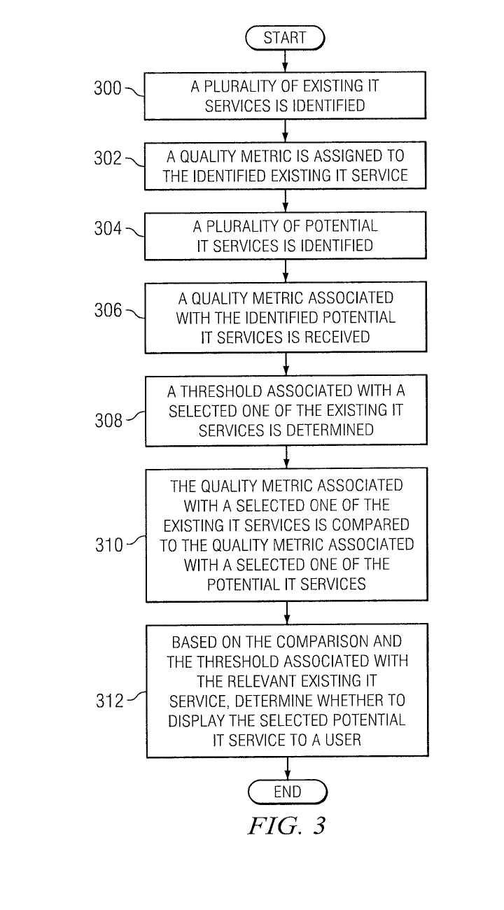

FIG. 3 is a flow diagram illustrating an operation in accordance with a particular embodiment of system 10. It should be understood that the flow diagram illustrated in FIG. 3 represents one example of an operation that may be performed in a particular embodiment of system 10. System 10 may perform other operations in accordance with particular embodiments as described in the present disclosure.

Operation, in the illustrated example, begins at step 300 with optimizing server 50 identifying a plurality of existing IT services. Optimizing server 50 may identify an IT service by retrieving information associated with one or more existing IT services from optimizing catalog 55 and/or enterprise catalog 30. In some embodiments optimizing server 50 retrieves service information 35 stored in enterprise server 30. Optimizing server 50 may store the retrieved service information 35 in optimizing catalog 55. As discussed above, optimizing catalog 55 stores a list of one or more IT services to monitor, and/or monitoring rules that identify IT services to monitor that meet predefined criteria. In some embodiments optimizing server 50 identifies an existing IT service by receiving user input that identifies one or more active or inactive IT services deployed in an enterprise. User input may specify a particular existing IT service to monitor.

At step 302 a quality metric is assigned to the identified existing IT service. In some embodiments enterprise catalog 30 and/or optimizing server 50 assigns one or more quality metrics to a particular IT service in service information 35. A quality metric may indicate a level of quality associated with one or more attributes of a relevant IT service, such as, for example, reliability, cost, performance, stability, usability, user ratings, and/or expert ratings. In particular embodiments, service information 35 may include an overall quality metric on a fixed or relative scale.

At step 304 optimizing server 50 identifies a plurality of potential IT services. Optimizing server 50 may identify an IT service by retrieving information associated with one or more potential IT services from potential catalog 40. As discussed above, potential catalog 40 stores a list of one or more potential IT services available to be deployed in an enterprise. In some embodiments, an enterprise may subscribe to a catalog service that maintains and updates information on available IT services. In some embodiments optimizing server 50 identifies a potential IT service by receiving user input that identifies one or more potential IT services.

At step 306 a quality metric associated with the identified potential IT services is received. Potential catalog 40 may receive one or more quality metrics associated with potential IT services from a third-party source. In some embodiments, potential catalog 40 receives one or more quality metrics based on user input. In some embodiments, potential catalog 40 indicates one or more quality metrics associated with a particular potential IT service in service information 45. A quality metric may indicate a level of quality associated with one or more attributes of a relevant IT service, such as, for example, reliability, cost, performance, stability, usability, user ratings, and/or expert ratings. In particular embodiments, service information 45 may include an overall quality rating on a fixed or relative scale. In particular embodiments, optimizing server 50 may receive one or more quality metrics from potential catalog 40. Potential catalog 40 may transmit service information 45 to optimizing server 50 in response to a request from optimizing server 50 and/or in response to updated service information 45.

At step 308, a threshold associated with a selected one of the existing IT services is determined. In particular embodiments, optimizing server 50 determines a threshold associated with the identified IT service. A threshold associated with each IT service in an enterprise may be stored in service information 35. In particular embodiments, a user may input into an interface of optimizing server 50 a threshold for each existing IT service, which optimizing server 50 stores in an associated service information 35 in enterprise catalog 30 and/or optimizing catalog 55. Optimizing server may determine a threshold associated with the identified IT service by retrieving the stored threshold from enterprise catalog 30 and/or optimizing catalog 50.

At step 310 the quality metric associated with a selected one of the existing IT services is compared to the quality metric associated with a selected one of the potential IT services. In particular embodiments, optimizing server 50 compares one or more quality metrics in service information 35 to one or more quality metrics in service information 45.

At step 312, based on the comparison and the threshold associated with the relevant existing IT service, it is determined whether to display the selected potential IT service to a user. In particular embodiments, optimizing server 50 may offer to enhance and/or replace the existing IT service associated with service information 45 with the potential IT service associated with service information 35. Optimizing server 50 may offer to enhance and/or replace the existing IT service by displaying the selected potential IT service on a display (such as, for example, a computer monitor) associated with optimizing server 50.

The steps illustrated in FIG. 3 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method comprising:
identifying a plurality of existing information technology services in an enterprise, wherein each of the plurality of existing information technology services includes a plurality of attributes;
assigning a quality metric associated with one or more attributes of each of the respective identified existing information technology services;
identifying a plurality of potential information technology services, wherein each of the plurality of potential information technology services includes a plurality of attributes;
receiving a quality metric associated with one or more attributes of each of the respective identified potential information technology services from a source external to the enterprise;
determining a threshold associated with a selected one of the existing information technology services;
comparing the quality metric associated with the selected one of the existing information technology services to the quality metric associated with a selected one of the potential information technology services; and
based at least in part on the comparison and the determined threshold, determining whether to display the potential information technology resource to a user.

2. The method of claim 1, wherein assigning a quality metric comprises:
receiving attribute quality information; and
based on the received attribute quality information, assigning a quality metric to one or more attributes of each of the respective identified existing information technology services.

3. The method of claim 1, wherein identifying a plurality of existing information technology services comprises:
receiving input from a user; and
based on the received input, storing information associated with existing information technology services in the enterprise.

4. The method of claim 1, wherein comparing at least one of the quality metrics associated with a selected one of the existing information technology services to at least one of the quality metrics associated with a selected one of the potential information technology services comprises:
receiving a comparison schedule, wherein the comparison schedule identifies:
the selected one of the existing information technology services;
the selected one of the potential information technology services; and
one or more comparison times, wherein the one or more comparison times each indicate at time at which to compare the selected one of the existing information technology services included in the comparison schedule and the selected one of the potential information technology services included in the comparison schedule; and
based on the comparison schedule, comparing at least one of the quality metrics associated with the selected one of the existing information technology services to at least one of the quality metrics associated with the selected one of the potential information technology services included in the comparison schedule at the one or more comparison times.

5. The method of claim 1, wherein the one or more attributes include cost, performance, stability, and security.

6. The method of claim 1, wherein the existing information technology services are provided by the enterprise.

7. The method of claim 1, wherein the existing information technology services are provided by a third party external to the enterprise.

8. The method of claim 1, wherein the potential information technology services are provided by the enterprise.

9. The method of claim 1, wherein the potential information technology services are provided by a third party external to the enterprise.

10. A system comprising:
an enterprise catalog operable to:
identify a plurality of existing information technology services in an enterprise, wherein each of the plurality of existing information technology services includes a plurality of attributes; and
assign a quality metric associated with one or more attributes of each of the respective identified existing information technology services;
a potential catalog operable to:
identify a plurality of potential information technology services, wherein each of the plurality of potential information technology services includes a plurality of attributes;
receive a quality metric associated with one or more attributes of each of the respective identified potential information technology services from a source external to the enterprise; and
an optimizing server operable to:
determine a threshold associated with a selected one of the existing information technology services;
compare the quality metric associated with the selected one of the existing information technology services to the quality metric associated with a selected one of the potential information technology services; and
based at least in part on the comparison and the determined threshold, determine whether to display the potential information technology resource to a user.

11. The system of claim 10, wherein the enterprise catalog is operable to assign a quality metric by:
receiving user input, wherein the user input identifies a quality metric associated with one or more attributes of each of the respective identified existing information technology services; and
based on the received attribute quality information, assign the quality metric to one or more attributes of each of the respective identified existing information technology services.

12. The system of claim 10, wherein the enterprise catalog is operable to identify a plurality of existing information technology services by:
receiving user input; and
based on the received input, storing information associated with existing information technology services in the enterprise.

13. The system of claim 10, wherein the optimizing server is operable to compare at least one of the quality metrics associated with a selected one of the existing information technology services to at least one of the quality metrics associated with a selected one of the potential information technology services by:
receiving a comparison schedule, wherein the comparison schedule identifies:
the selected one of the existing information technology services;
the selected one of the potential information technology services; and
one or more comparison times, wherein the one or more comparison times each indicate at time at which to compare the selected one of the existing information technology services included in the comparison schedule and the selected one of the potential information technology services included in the comparison schedule; and
based on the comparison schedule, comparing at least one of the quality metrics associated with the selected one of the existing information technology services to at least one of the quality metrics associated with the selected one of the potential information technology services included in the comparison schedule at the one or more comparison times.

14. The system of claim 10, wherein the one or more attributes include cost, performance, stability, and security.

15. The system of claim 10, wherein the existing information technology services are provided by the enterprise.

16. The system of claim 10, wherein the existing information technology services are provided by a third party external to the enterprise.

17. The system of claim 10, wherein the potential information technology services are provided by the enterprise.

18. The system of claim 10, wherein the potential information technology services are provided by a third party external to the enterprise.

19. A computer readable non-transitory medium encoded with logic, the logic operable, when executed on a processor to:
identify a plurality of existing information technology services within an enterprise, wherein each of the plurality of existing information technology services includes a plurality of attributes; and
assign a quality metric associated with one or more attributes of each of the respective identified existing information technology services;
identify a plurality of potential information technology services, wherein each of the plurality of potential information technology services includes a plurality of attributes;
receive a quality metric associated with one or more attributes of each of the respective identified potential information technology services from a source external to the enterprise;
determine a threshold associated with a selected one of the existing information technology services;
compare the quality metric associated with the selected one of the existing information technology services to the quality metric associated with a selected one of the potential information technology services; and
based at least in part on the comparison and the determined threshold, determine whether display the potential information technology resource to a user.

20. The computer readable non-transitory medium of claim 19, wherein the logic is operable to assign a quality metric by:
receiving user input, wherein the user input identifies a quality metric associated with one or more attributes of each of the respective identified existing information technology services; and
based on the received attribute quality information, assign the quality metric to one or more attributes of each of the respective identified existing information technology services.

21. The computer readable non-transitory medium of claim 19, wherein the logic is operable to identify a plurality of existing information technology services by:
receiving user input; and
based on the received input, storing information associated with existing information technology services in the enterprise.

22. The computer readable non-transitory medium of claim 19, wherein the logic is operable to compare at least one of the quality metrics associated with a selected one of the existing information technology services to at least one of the quality metrics associated with a selected one of the potential information technology services by:
receiving a comparison schedule, wherein the comparison schedule identifies:
the selected one of the existing information technology services;
the selected one of the potential information technology services; and
one or more comparison times, wherein the one or more comparison times each indicate at time at which to compare the selected one of the existing information technology services included in the comparison schedule and the selected one of the potential information technology services included in the comparison schedule; and
based on the comparison schedule, comparing at least one of the quality metrics associated with the selected one of the existing information technology services to at least one of the quality metrics associated with the selected one of the potential information technology services included in the comparison schedule at the one or more comparison times.

23. The computer readable non-transitory medium claim 19, wherein the one or more attributes include cost, performance, stability, and security.

24. The computer readable non-transitory medium claim 19, wherein the existing information technology services are provided by the enterprise.

25. The computer readable non-transitory medium claim 19, wherein the existing information technology services are provided by a third party external to the enterprise.

26. The computer readable non-transitory medium claim 19, wherein the potential information technology services are provided by the enterprise.

27. The computer readable non-transitory medium claim 19, wherein the potential information technology services are provided by a third party external to the enterprise.

28. A system comprising:
means for identifying a plurality of existing information technology services in an enterprise, wherein each of the plurality of existing information technology services includes a plurality of attributes;
means for assigning a quality metric associated with one or more attributes of each of the respective identified existing information technology services;
means for identifying a plurality of potential information technology services, wherein each of the plurality of potential information technology services includes a plurality of attributes;
means for receiving a quality metric associated with one or more attributes of each of the respective identified potential information technology services from a source external to the enterprise;
means for determining a threshold associated with a selected one of the existing information technology services;
means for comparing the quality metric associated with the selected one of the existing information technology services to the quality metric associated with a selected one of the potential information technology services; and
means for, based at least in part on the comparison and the determined threshold, determining whether to display the potential information technology resource to a user.
